(19) United States
(12) Patent Application Publication
(10) Pub. No.: US 2005/0099755 A1
(43) Pub. Date: May 12, 2005

(54) Broadband surge protector with non-resetting current limiter

(76) Inventors: David Martin, Lake Arrowhead, CA (US); Curtis Dietzsch, Moreno Valley, CA (US)

Correspondence Address: KLEIN, O'NEILL & SINGH, 2 PARK PLAZA, SUITE 510, IRVINE, CA, 92614, US

(21) Appl. No.: 10/705,415

(22) Filed: Nov. 10, 2003

(51) Int. Cl. H02H 9/06

(52) U.S. Cl. 361/120

(57) ABSTRACT

A surge protection device includes a gas discharge tube surge protector connected between a Tip line and a Ring line, and further includes solid state heat-generating resistive elements in the Tip and Ring lines, and thermally-responsive sneak current grounding switches in the Tip and Ring lines that have an untripped position connecting Tip and Ring line terminals of the surge protector respectively to the Tip and Ring line resistive elements, and a tripped position in which they ground the Tip and Ring line terminals. The switches are switched to their tripped position in response to the heat generated in the resistive elements as a consequence of current passing through them that exceeds a predetermined current level. A surge suppression element is connected in parallel with each of the resistive elements. The resistive elements are preferably carbon film resistors, and the surge suppression elements are preferably transient voltage suppression diodes.

### CROSS-REFERENCE TO RELATED APPLICATION

Not Applicable

### FEDERALLY SPONSORED RESEARCH OR DEVELOPMENT

Not Applicable

### BACKGROUND OF THE INVENTION

The present invention is directed to an electrical surge protection device of the type used to protect equipment and electrical circuits from being damaged by overvoltage surges and/or overcurrent surges.

Surge protection devices may be used to protect power lines, communication lines, and electrical equipment connected to power lines and communication lines from overvoltage surges, such as may be caused by lightning or power line cross conditions, for example. A power line cross condition, which may be caused by a downed power line, consists of an excessive voltage and an alternating current (typically 60 Hz) of excessive amplitude. Overcurrent conditions can result from induced currents from nearby power lines

During an overvoltage surge, a surge protection device may provide temporary surge protection by shunting the overvoltage to ground. In the presence of a prolonged overvoltage condition, a surge protection device may also be designed to fail in a short circuit state.

In the context of a telecommunications circuit (e.g., a subscriber loop interface circuit, or “SLIC”), which includes a line pair comprising a tip line and a ring line, each having an input terminal and an output terminal, surge protection devices are typically placed between the tip line and ground, and between the ring line and ground. When an overvoltage is presented on either or both of the lines, the overvoltage device changes from a high impedance to a low impedance, thereby shunting the overvoltages and their related currents to ground. Once the overvoltage condition has passed, the devices revert to their high impedance state.

Various types of overvoltage surge protectors are known. They may employ one or more of the following types of overvoltage-responsive elements: gas discharge tubes, metal oxide varistors, air-gaps, and thyristors. The following U.S. Patents exemplify prior art surge protection devices: No. 5,388,023—Boy et al.; No. 5,500,782—Oertel et al.; 5,880,919—Napiorkowski et al.; and 6,327,129—Oertel et al.

A secondary problem that many prior art surge protection devices attempt to address is the occurrence of so-called “sneak currents.” Sneak currents are undesired currents that may be induced or otherwise generated in one or both lines of the line pair, and that have an amplitude that may be high enough to damage circuits and/or components, but not high enough to trip or activate the overvoltage surge protection device itself. To eliminate or substantially reduce sneak currents, many prior art surge protection devices use a wirewound resistive element connected in series with each of the wires of the line pair to actuate a thermally-sensitive mechanism by ohmic (I²R) heating. This mechanism is typically not resettable, and permanently diverts the sneak current to ground or open-circuits the affected line. This non-resetting characteristic is preferred by certain high volume users of surge protection devices.

The use of wirewound resistive elements, while acceptable in many applications, has the characteristic of attenuating high frequency signals due to high inductive reactance. This is a serious drawback when it is desired to transmit high data rate signals using modem telecommunications technologies, such as VDSL and ADSL, which use existing wired telecommunications infrastructure. Accordingly, alternative approaches to the sneak current problem have been sought, which use other types of resistive elements. For example, solid state resistive elements are shown for providing overcurrent protection in a telecommunications surge protection device or circuit in the following U.S. Pat. No. 4,907,120—Kaczmarek et al.; No. 5,410,596—Shannon et al.; No. 5,155,649—Hung et al.; and No. 6,104,591—Casey et al. While this approach has shown promise, the resistive elements used in many of the prior art devices of this nature may not have adequate overvoltage surge tolerance, or they may not have sufficiently rapid reaction times. In some other prior art devices, the sneak protection function may add undesirable costs and/or complexity of manufacture.

There has thus been a need for a telecommunications surge protection device that provides protection in SLIC circuits and the like against sneak currents without significant high frequency signal attenuation, and without compromising the overvoltage function. Furthermore, these advantages should be provided in a device that is not significantly greater in cost or substantially more complex than prior art devices.

### SUMMARY OF THE INVENTION

Broadly, the present invention, in a preferred embodiment, is a surge protection device, of the type including a gas discharge tube connected between a Tip line and a Ring line, wherein the improvement comprises: a first solid state heat-generating resistive element connected in the Tip line; a second solid state heat-generating resistive element connected in the Ring line; a first surge suppression element connected in the Tip line in parallel with the first heat-generating resistive element; and a second surge suppression element connected in the Ring line in parallel with the second heat-generating resistive element; wherein the first resistive element and the first surge suppression element are connected in series with a first thermally-responsive sneak current-grounding switch in the Tip line, and wherein the second resistive element and the second surge suppression element are connected in series with a second thermally-responsive sneak current-grounding switch 36 in the Ring line.

More specifically, in a preferred embodiment, the surge protection device comprises a gas discharge tube (“GDT”) having three electrodes, the first of which is connected to the Tip line, the second of which is connected to the Ring line, and the third of which is connected to a ground line. A first metal oxide varistor (“MOV”) is connected between the Tip line and the ground line, and a second MOV is connected between the Ring line and the ground line. A first thermally-responsive surge grounding switch is connected between the Tip line and the ground line in parallel with the first MOV, and a second thermally-responsive surge grounding switch is connected between the Ring line and the ground line, in parallel with the second MOV. High voltage transients are clamped by the MOVs and/or the GDT. A sustained overvoltage condition will generate sufficient ohmic heating to close one or both of the thermally-responsive surge-grounding switches, so that the overvoltage is conducted to the ground line.

The sneak current mechanism, in accordance with a preferred embodiment of the present invention, is provided in each of the Tip and Ring lines, preferably on the central office exchange (COE) side of the surge protector. This mechanism comprises a first solid state (preferably carbon film) heat-generating resistive element connected in the Tip line, and a second similar heat-generating resistive element connected in the Ring line. The mechanism further comprises a first surge suppression element connected in the Tip line in parallel with the first heat-generating resistive element, and a second surge suppression element connected in the Ring line in parallel with the second heat-generating resistive element. The first resistive element and the first surge suppression element are connected in series with a first thermally-responsive sneak current-grounding switch in the Tip line, while the second resistive element and the second surge suppression element are connected in series with a second thermally-responsive sneak current-grounding switch in the Ring line. The first sneak-current grounding switch has a normal position in which it provides an electrical path between a Tip line output terminal of the surge protector and the first resistor, and a tripped position in which it connects the Tip line output terminal to the ground line. Likewise, the second sneak current-grounding switch has a normal position in which it provides an electrical path between a Ring line output terminal of the surge protector and the second resistor, and a tripped position in which it connects the Ring line output terminal to the ground line.

In a specific preferred embodiment of the invention, the first and second resistive elements are carbon film resistors that are physically small enough to create sufficient localized ohmic (I²R) heating to actuate the thermally-responsive sneak current-grounding switches so that they switch from their normal position to their tripped position, as described above. Resistors of such size, however, may not be sufficiently surge-tolerant for the applications in which the surge protection device is likely to be employed. To this end, the surge suppression elements are connected in parallel with the resistors to divert most of the surge energy around the resistors. In a preferred embodiment, the surge suppression elements are bipolar transient voltage suppression (“TVS”) diodes, with clamping voltages that are high enough for the diodes to remain non-conductive when the current through the resistors is at or below the desired transition or operating current level (that is, the current level at which sufficient heat is generated to trip the sneak current-grounding switches), and low enough to provide adequate surge protection for the resistors.

### BRIEF DESCRIPTION OF THE DRAWINGS

FIG. 1 is a front perspective view of a surge protection device with a current limitation function, in accordance with a preferred embodiment of the present invention;

FIG. 2 is a front elevational view of the device of FIG. 1;

FIG. 3 is a side elevational view of the device of FIG. 1;

FIG. 4 is cross-sectional view taken along line 4-4 of FIG. 2;

FIG. 5 is a schematic view of the device of FIG. 1 in a typical telecommunications SLIC; and

FIG. 6 is an exploded view of the device of FIG. 1.

### DETAILED DESCRIPTION OF THE PREFERRED EMBODIMENT

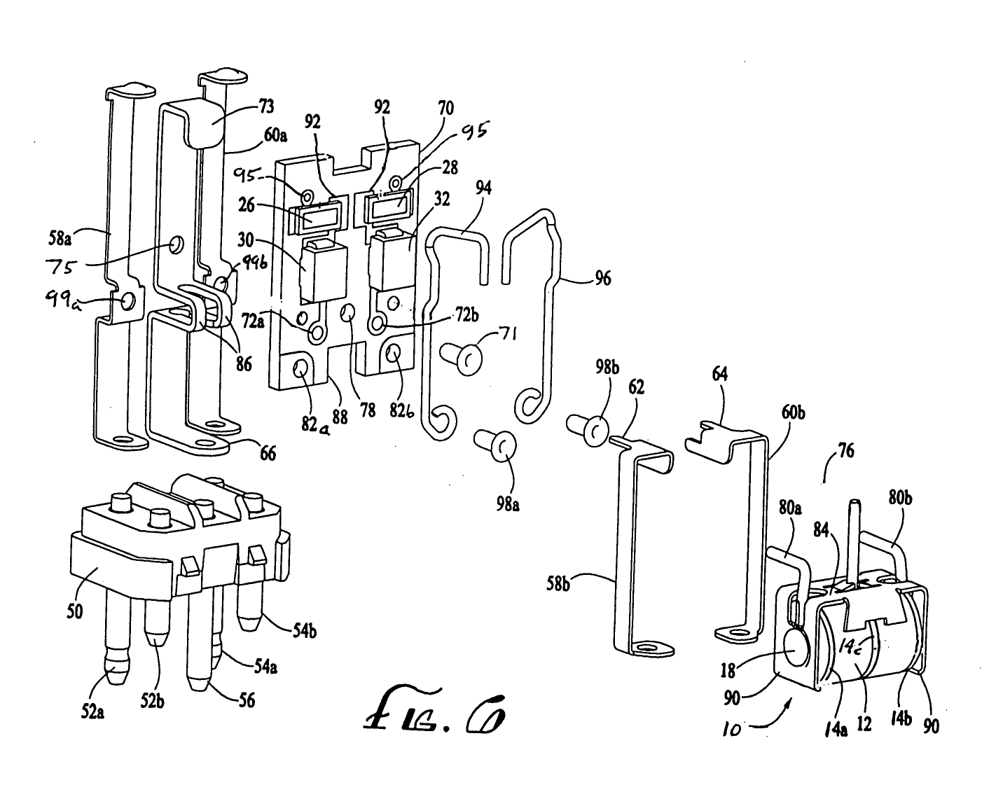

Referring first to FIG. 5, a surge protection device 100 with sneak current protection, in accordance with a preferred embodiment of the present invention, is shown connected between the Tip and Ring lines of a typical telecommunications subscriber line interface circuit (“SLIC”). The device of the invention includes a multi-stage surge protector 10, as described in U.S. Pat. No. 6,327,129—Oertel et al., the disclosure of which is incorporated herein by reference. Briefly described, the surge protector 10 comprises a gas discharge tube (“GDT”) 12 having three electrodes, 14a, 14b, 14c, the first of which is connected to the Tip line, the second of which is connected to the Ring line, and the third of which is connected to a ground line 16. A first metal oxide varistor (“MOV”) 18 is connected between the Tip line and the ground line 16, and a second MOV 20 is connected between the Ring line and the ground line 16. In a specific embodiment of the invention, the GDT 12 has breakdown voltage of 330V, meaning it becomes conductive at 330V, while the two MOVs 18, 20 each have a clamping voltage of about 430V. A first thermally-responsive surge grounding switch 22 is connected between the Tip line and the ground line 16 in parallel with the first MOV 18, and a second thermally-responsive surge grounding switch 24 is connected between the Ring line and the ground line 16, in parallel with the second MOV 20.

The operation of the surge protector 10 is described in detail in the aforementioned patent to Oertel et al., and need not be repeated in detail here. Briefly, however, high voltage transients are clamped by the MOVs 18,20 and/or the GDT 12. A sustained overvoltage condition will generate sufficient ohmic heating to close one or both of the thermally-responsive surge-grounding switches 22, 24, so that the overvoltage is conducted to the ground line 16.

The sneak current mechanism, in accordance with the present invention, is provided in each of the Tip and Ring lines, preferably on the central office exchange (COE) side of the surge protector 10. This mechanism comprises a first solid state (preferably carbon film) heat-generating resistive element 26 connected in the Tip line, and a second similar heat-generating resistive element 28 connected in the Ring line. The mechanism further comprises a first surge suppression element 30 connected in the Tip line in parallel with the first heat-generating resistive element 26, and a second surge suppression element 32 connected in the Ring line in parallel with the second heat-generating resistive element 28. The first resistive element 26 and the first surge suppression element 30 are connected in series with a first thermally-responsive sneak current-grounding switch 34 in the Tip line, while the second resistive element 30 and the second surge suppression element 32 are connected in series with a second thermally-responsive sneak current-grounding switch 36 in the Ring line. The first sneak-current grounding switch 34 has a normal position in which it provides an electrical path between a Tip line terminal 38 of the surge protector 10 and the first resistor 26, and a tripped position in which it connects the Tip line terminal 38 to the ground line 16. Likewise, the second sneak current-grounding switch 36 has a normal position in which it provides an electrical path between a Ring line terminal 40 of the surge protector 10 and the second resistor 30, and a tripped position in which it connects the Ring line terminal 40 to the ground line 16.

In a specific embodiment of the invention, the first and second resistive elements 26, 28 are carbon film resistors, preferably of about 3.6 ohms. Such resistors are inexpensive, non-inductive, and low noise. In a practical embodiment, the resistors are small enough in physical dimensions to create sufficient localized ohmic (I²R) heating to actuate the thermally-responsive sneak current-grounding switches 34, 36 so that they switch from their normal position to their tripped position, as described above. Resistors of such size, however, may not be sufficiently surge-tolerant for the applications in which the surge protection device is likely to be employed. Specifically, the device 100 typically must be able to withstand at least thirty (30) applications of at least 25 amperes peak current, at about 1000 volts, with a 10/1000 microsecond impulse waveform. To this end, the surge suppression elements 30, 32 are connected in parallel with the resistors 26, 28 to divert most of the surge energy around the resistors.

In a preferred embodiment, as shown in FIG. 5, the surge suppression elements 30, 32 are bipolar transient voltage suppression (“TVS”) diodes. The clamping voltage of the TVS diodes 30, 32 must be high enough for the diodes to remain non-conductive when the current through the resistors 26, 28 is at or below the desired transition or operating current level (that is, the current level at which sufficient heat is generated to trip the sneak current-grounding switches 34, 36), and low enough to provide adequate surge protection for the resistors 26, 28. For example, a 3.6 ohm resistor with a transition current of 0.8 amperes would experience a voltage drop across it of 2.88V. Thus, the TVS diode connected in parallel would need to have a clamping voltage of at least 2.88V, and preferably several volts higher. For most applications, adequate surge protection for the resistors 26, 28 is provided by a TVS diode with a clamping voltage between about 10V and about 17V.

It will be appreciated by those skilled in the pertinent arts that other types of surge suppression elements may be employed instead of the TVS diodes 30, 32. For example, such components as Zener diodes, rectifier diode strings, thyristors, MOVs, or any of the polymer-based surge protective devices that are known in the art, may be found to be acceptable or advantageous in certain applications.

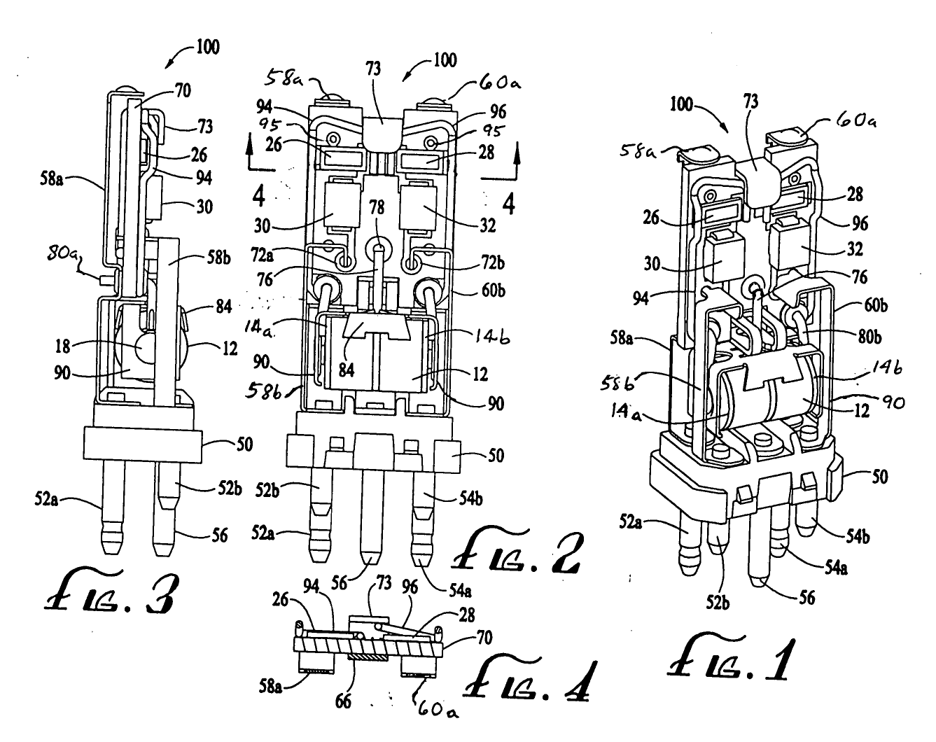

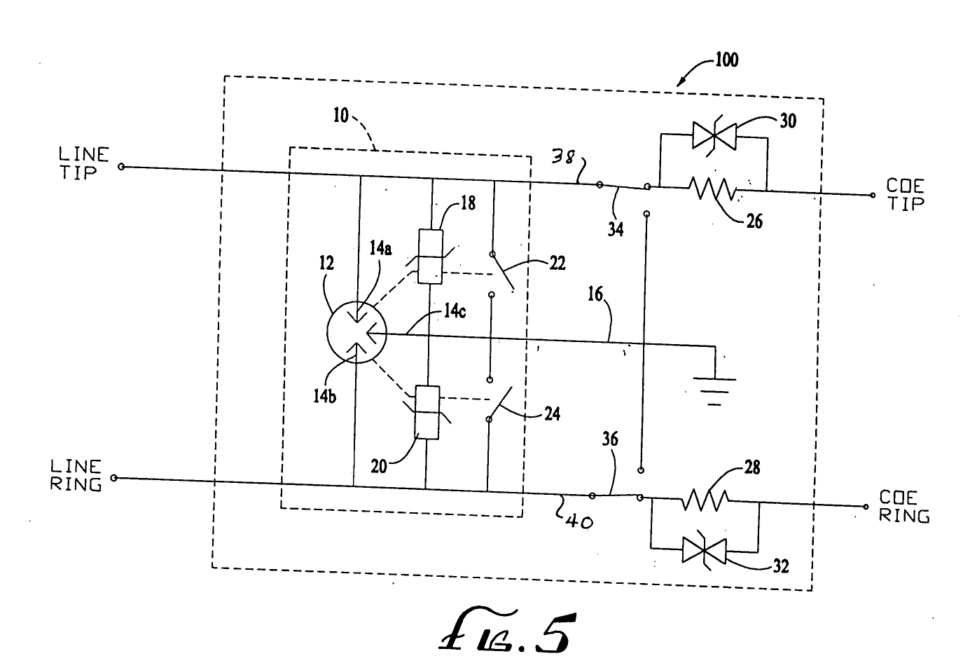

FIGS. 1-4 and 6 illustrate a preferred physical structure for a surge protection device 100 in accordance with the preferred embodiment of the invention.

As illustrated, the device 100 is embodied in an assembly comprising an insulative base 50 having five (5) terminal pins, as follows: a Tip line long pin 52a, a Tip line short pin 52b, a Ring line long pin 54a, a Ring line short pin 54b, and a ground pin 56. The long pins 52a, 54a are typically connected to the line or field side of the SLIC, while the short pins 52b, 54b are typically connected to the COE side of the SLIC. The ground pin 56 is connected to the ground line 16 (FIG. 5).

Connected to the Tip line long pin 52a is a first Tip line conductor strip 58a, and connected to the Tip line short pin 52b is a second Tip line conductor strip 58b. Likewise, a first Ring line conductor strip 60a is connected to the Ring line long pin 54a, and a second Ring line conductor strip 60b is connected to the Ring line short pin 54b. The second Tip line conductor strip 58b has an upper end terminating in a rearwardly-extending prong 62; a similar rearwardly extending prong 64 extends from the upper end of the second Ring line conductor strip 60b. A ground conductor strip 66, connected to the ground pin 56, is advantageously arranged so that it is centrally located between the Tip and Ring line conductor strips 58a, 58b, 60a, 60b.

The surge protector 10 is mounted on an insulative circuit board 70 having metallized apertures 72a, 72b located to receive the prongs 62, 64, respectively. The metallized apertures 72a, 72b form first terminals for the first and second surge suppression elements 30, 32, respectively, and the prongs 62, 64 are attached by solder to their respective terminals.

The ground conductor strip 66 is connected to the rear surface of the circuit board 70 by a first conductive eyelet 71 that passes through a central aperture 78 in the circuit board 70 and a registering aperture 75 in the ground conductor strip 66. The ground conductor strip 66 extends over the upper edge of the circuit board 70, forming a downwardly-depending contact portion 73. The ground conductor strip 66 is also formed with a pair of forward extensions 86 that extend forward through a cut-out 88 in the lower edge of the circuit board 70, as best shown in FIG. 6.

The GDT 12 has first and second end electrodes 14a, 14b that are connected to first and second leads 80a, 80b, respectively. The GDT 12 has a central, ground lead 76, one end of which is connected to the third, ground terminal 14c. The other end of the ground lead 76 contacts the forward extensions 86 of the ground conductor strip 66. The end electrodes 14a, 14b are recessed to hold the first and second MOVs 18, 20, respectively, whereby contact is established between a first terminal (not shown) of each MOV and its associated end electrode. The GDT 12 is held in a conductive bracket 84 that makes electrical contact, on its upper surface, with the ground lead 76 of the GDT 12 and with the forward extensions 86 of the ground conductor strip 66. The bracket 84 has a downwardly-extending arm 90 at each end that is spring-biased inwardly (i.e., toward the end electrodes 14a, 14b), and establishes contact with a second terminal (not shown) of the adjacent MOV by means of a conductive stand-off member (not shown) that is bonded to each of the arms by a eutectic component that melts in the presence of a sustained overvoltage condition. The standoff members normally keep the arms 90 out of contact with the end electrodes 14a, 14b, but, under a sustained overvoltage condition, ohmic heating melts the eutectic component, allowing the spring-biased arms 90 to move into contact with the end electrodes 14a, 14b to shunt the overvoltage to the ground conductor strip 66 through the bracket 84. This mechanism is described in detail in the aforementioned patent to Oertel et al.

The sneak current protection mechanism described above in connection with FIG. 5 is mounted on the circuit board 70. The heat generating resistive elements 26, 28 and the surge suppression elements 30, 32 are mounted on the front surface of the circuit board 70. These components are connected in the circuit configuration shown in FIG. 5 by appropriate conductive traces on, and conductive vias through, the circuit board 70, by conventional techniques well-known in the art.

Specifically, as best shown in FIG. 6, each of the resistive elements 26, 28 is contacted by a conductive terminal pad 92, forming a first terminal for each of the resistive elements 26, 28. Each of the surge suppression devices 30, 32 has a second terminal 93 that is connected to the conductive pad 92 of one of the resistive elements 26, 28. A metallized via 95 is conductively connected to each of the resistive elements 26, 28, forming a second terminal for each of the resistive elements. Each of the vias 95 is conductively connected by a metallized trace (not shown) on the rear surface of the circuit board to one of the metallized through-holes 72a, 72b that form the first terminals of the surge suppression elements 30, 32, respectively, as described above. It will thus be appreciated that each of the surge suppression elements 30, 32, is connected in parallel with one of the resistive elements 26, 28, as shown schematically in FIG. 5.

The function of the above-described thermally-responsive sneak current grounding switches 34, 36 is performed by first and second spring contacts 94, 96, respectively. The first spring contact 94 has a first end that is connected to the first Tip line conductor strip 58a and to the circuit board 70 by means of a second conductive eyelet 98a that passes through a first metallized hole 82a in the circuit board 70 and a hole 99a in the first Tip line conductor strip 58a. Likewise, the second spring contact 96 has a first end that is connected to the first Ring line conductor strip 60a and the circuit board 70 by means of a third conductive eyelet 98b that passes through a second metallized hole 82b in the circuit board 70 and a hole 99b in the first Ring line conductor strip 60a. The conductive eyelets 98a, 98b are hollow so that they can receive and make electrical contact with the first and second leads 80a, 80b of the GDT 12. Thus, the first and second spring contacts 94, 96 are in electrical contact with the first and second leads 80a, 80b, respectively through the eyelets 98a, 98b, respectively. Also, the eyelet 98a establishes an electrical connection between the first spring contact 94 and the first Tip line conductor strip 58a, while the eyelet 98b establishes an electrical connection between the second spring contact 96 and the first Ring line conductor strip 60a.

The spring contacts 94, 96 are formed and mounted so that each has a second end that is spring biased away from the front surface of the circuit board 70. The respective second ends of the spring contacts 94, 96 are bonded to the terminal pads 92 of the resistive elements 26, 28, respectively, by a conductive eutectic material, such as solder, that melts or otherwise changes physical state in response to heat. When a sneak current passes through one of the resistive elements 26, 28, the ohmic heating causes the eutectic material to change state, releasing the second end of the associated spring contact from the pad 92, and causing the spring contact to spring away from the pad 92 (due to the aforementioned bias), thereby to come into contact with the contact portion 73 of the ground conductor strip 66. Thus, as shown in FIG. 4, the second end of the second spring contact 96 is shown in contact with the contact portion 73 of the ground conductor strip 66, after having been released from the terminal pad 92 of the second resistive element 28 by the change of state of the eutectic material due to ohmic heating generated by a sneak current of qualified magnitude passing through the second resistive element. The second end of the first spring contact 94 remains in contact with the terminal pad 92 of the first resistive element 26, inasmuch as no sneak current (or a sneak current of less than the qualifying magnitude) has passed through the first resistive element.

1. A surge protection device, of the type including a gas discharge tube surge protector connected between a Tip line and a Ring line, wherein the improvement comprises:
a first thermally-responsive sneak current-grounding switch in the Tip line;
a second thermally-responsive sneak current-grounding switch in the Ring line;
a first solid state heat-generating resistive element connected in the Tip line in series with the first sneak current-grounding switch;
a second solid state heat-generating resistive element connected in the Ring line in series with the second sneak current-grounding switch;
a first surge suppression element connected in the Tip line in parallel with the first heat-generating resistive element; and
a second surge suppression element connected in the Ring line in parallel with the second heat-generating resistive element.

2. The surge protection device of claim 1, wherein the gas discharge tube surge protector has a Tip line terminal and a Ring line terminal, and wherein the first sneak current-grounding switch has an untripped position in which the Tip line terminal is connected to the first solid state heat-generating element, and a tripped position in which the Tip line terminal is grounded; and
wherein the second sneak current-grounding switch has an untripped position in which the Ring line terminal is connected to the second solid state heat-generating element, and a tripped position in which the Ring line terminal is grounded.

3. The surge protection device of claim 2, wherein the first and second sneak current grounding switches are switched from their untripped position to their tripped position in response to ohmic heating of the first and second solid state heat-generating resistive elements as a consequence of a current passing through the resistive elements that exceeds a predetermined current level.

4. The surge protection device of claim 1, wherein the first and second heat-generating resistive elements are carbon film resistors.

5. The surge protection device of claim 1, wherein the first and second surge suppression elements are bipolar transient voltage suppression diodes.

6. The surge protection device of claim 2, wherein the first and second surge suppression elements are diodes having a clamping voltage that is within a range in which the diodes remain non-conductive when the current through the resistive elements is at or below the predetermined current level, and in which the diodes protect the resistive elements from expected voltage surges.

7. The surge protection device of claim 6, wherein the first and second surge suppression elements are bipolar transient voltage suppression diodes.

8. The surge protection device of claim 6, wherein the clamping voltage is in the range of about 10V to about 17V.

9. A surge protection device, of the type including a gas discharge tube surge protector connected between a Tip line and a Ring line, wherein the gas discharge tube surge protector has a Tip line terminal and a Ring line terminal, and wherein the improvement comprises:
a first solid state heat-generating resistive element in the Tip line that exhibits ohmic heating in response to current passing through it;
a first thermally-responsive sneak current grounding switch having an untripped position in which it connects the Tip line terminal to the first resistive element, and a tripped position in which it connects the Tip line terminal to ground;
a first solid state heat-generating resistive element in the Tip line that exhibits ohmic heating in response to current passing through it;
a second thermally-responsive sneak current grounding switch having an untripped position in which it connects the Ring line terminal to the second resistive element, and a tripped position in which it connects the Ring line terminal to ground;
a first surge suppression element connected in the Tip line in parallel with the first heat-generating resistive element; and
a second surge suppression element connected in the Ring line in parallel with the second heat-generating resistive element;
wherein the first and second sneak current grounding switches are switched from their untripped position to their tripped position in response to ohmic heating of the first and second solid state heat-generating resistive elements as a consequence of a current passing through the resistive elements that exceeds a predetermined current level.

10. The surge protection device of claim 9, wherein the first and second heat-generating resistive elements are carbon film resistors.

11. The surge protection device of claim 9, wherein the first and second surge suppression elements are bipolar transient voltage suppression diodes.

12. The surge protection device of claim 9, wherein the first and second surge suppression elements are diodes having a clamping voltage that is within a range in which the diodes remain non-conductive when the current through the resistive elements is at or below the predetermined current level, and in which the diodes protect the resistive elements from expected voltage surges.

13. The surge protection device of claim 12, wherein the first and second surge suppression elements are bipolar transient voltage suppression diodes.

14. The surge protection device of claim 12, wherein the clamping voltage is in the range of about 10V to about 17V.
